(19) United States
(12) Patent Application Publication
(10) Pub. No.: US 2014/0273160 A1
(43) Pub. Date: Sep. 18, 2014

(54) NOVEL BACTERIAL STRAINS FOR BIOLOGICAL CONTROL OF MOSQUITOES

(71) Applicants: Fikrettin Sahin, Istanbul (TR); Gulengul Duman, Istanbul (TR); Muge Yazici, Istanbul (TR)

(72) Inventors: Fikrettin Sahin, Istanbul (TR); Gulengul Duman, Istanbul (TR); Muge Yazici, Istanbul (TR)

(73) Assignee: YEDITEPE UNIVERSITESI, Istanbul (TR)

(21) Appl. No.: 14/130,969

(22) PCT Filed: Jul. 5, 2012
(86) PCT No.: PCT/IB2012/053426

§ 371 Date: Jan. 6, 2014

(30) Foreign Application Priority Data
Jul. 5, 2011 (TR) 2011/06664

(51) Int. Cl. A01N 63/00; C12R 1/07

(52) U.S. Cl. CPC A01N 63/00; C12R 1/07
USPC 435/252.5

(57) ABSTRACT

The present invention relates to novel bacteria strains that can be used in biological control against mosquito larvae (Culex spp.). The protein obtained from a novel B. sphaericus spp. isolates with the invention is used as larvicide, the step of isolating the protein at product obtaining stage is eliminated. By means of the invention, thee bacterial strains (MIB 5,6,7) investigated for biological control of mosquitoes are effective in both polluted and fresh water.

### INCORPORATION OF SEQUENCE LISTING

The Sequence Listing that is contained in the file named “final-GBAP023_ST25.txt”, which is 4,358 bytes in size (measured in Windows XP) and which was recorded on Apr. 15, 2014 are herein incorporated by reference.

### FIELD OF THE INVENTION

The present invention relates to novel bacteria strains that can he used in biological control against mosquito larvae (Culex spp.).

### BACKGROUND OF THE INVENTION

Mosquitoes are vectors of many diseases such as Mosquito-borne arboviruses, malaria, filariasis and Japan encephalitis. Generally mosquito control does with chemical pesticides more than biopesticides in the world. These chemical pesticides are known as dichlorodiphenyltrichloro ethane (DDT), gammaxane, malathion, chlordane and organophosphates. All of them have high toxic range for human health and environment. Compared to chemical pesticide, microbial insecticides are often species specific and do not contaminate environment, therefore, safe to non-target organisms in the nature. Among various microbial pesticides, Bacillus thrungiensis and Bacillus sphaericus are being widely used. Mosquitocidal bacteria are environmentally friendly alternatives to chemical pesticides for controlling water mosquitoes.

Bacillus thrungiensis subs. israilensis (Bti) is the most extensively used mosquito larvicidal bacteria in the world. Bti produces crystal glycoprotein (protoxin) coded by different genes such as Cry4A, Cry4B, Cry10, A, Cry11A and Cry1A during sporulation. Bti Cry toxins have been widely used in the control of broad range of mosquito and blackfly species as well as nematodes mite and protozoa. Another potential microbial pesticide insecticide, Bacillus sphaericus, is known to be effective against Culex spp. and Anopheles spp. species, and has better residual activity in polluted waters by production of binary toxin (Bin) and mosquitocidal toxins (Mtx). Mosquito resistance to some of B. sphaericus strains carrying a single Bin (binary) toxin gene have been reported in many countries

European Patent document no EP0349769, an application known in the state of the art, discloses Bacillus sphaericus bacteria genetically engineered with toxin producing genes taken from Bacillus thuringiensis var. israelensis (B.t.i.) bacteria and transferred to Bacillus sphaericus strains. The genetically modified (GM) Bacillus sphaericus strains produced are capable of producing. B.t.i. toxins in effective amounts and can control against mosquito larvae and black flies effectively.

European Patent document no EP0454485, an application known in the state of the art, discloses using insect killing toxins obtained from Bacillus thuringiensis or Bacillus sphaericus bacteria against pests living in water such as mosquito larvae. The spores of these bacteria kill some insect larvae feeding on these spores. The spores are digested in intestines of the larvae and release their toxins and neutralize the larvae. The known applications in the technique disclose taking toxins of the bacteria to apply on larvae for biological control against mosquito. Taking the toxins of the bacteria requires extra labor and cost. That is, protein isolation step is performed in these applications.

Even though, many commercial products are introduced to the market, development resistance in mosquito populations to some known biological control products are always great need and force for the scientists to search for new natural mosquitocidal bacterial strains which can be used for development of new strains for development of new commercial microbial insecticide.

### SUMMARY OF THE INVENTION

The objective of the present invention is to provide novel bacterial strains that can be used as larvicide in biological control.

A further objective of the present invention is to provide novel bacterial strains for biological control wherein the toxin protein isolation step in product obtaining state is eliminated.

Another objective of the present invention is to provide novel bacterial strains for biological control which are effective in both polluted and fresh water.

### DETAILED DESCRIPTION OF THE INVENTION

“Novel Bacterial Strains for Biological Control of Mosquitoes” developed to fulfill the objective of the present invention is illustrated in the accompanying figures wherein.

FIG. 1 Bin 51 and bin 42 toxin genes PCR amplified by primers B. sph; B. sphaericus, MBI5, MBI6 and MBI7

FIG. 2 Mtx 1 and Mtx 2 toxin genes PCR amplified by primers.
B. sph: B. sphaericus, MBI5, MBI6 and MBI7

FIG. 3 is the PCR bands of MBI5, MBI6 and MBI7 bacterial strains in gel imaging system (BIORAD) after electrophoresis in 1% agarose gel with ethidium bromide (C: Negative Control).

FIG. 4 Neighbour-joining tree: the phylogenetic relationships among the Bacillus sphaericus-like strains.

FIG. 5 is the scanning electron microscope image of B. sphaericus bacterial cells.

FIG. 6 is the scanning electron microscope image of MBI5 bacterial strains.

FIG. 7 is the scanning electron microscope image of MBI6 bacterial strains.

FIG. 8 is the scanning electron microscope image of MBI7 bacterial strains.

FIG. 9 is the 16 rDNA sequence of MBI5 bacterial strain.

FIG. 10 is the 165 rDNA sequence of MBI6 bacterial strain.

FIG. 11 is the 16S rDNA sequence of MBI7 bacterial strain.

In the inventive biological control against the mosquito larvae, the strains of B. sphaericus species are applied against the mosquito larvae. Deposit number is taken for the inventive strains from United States Department of Agriculture Research. Education and Economics Agricultural Research Service on Jan. 28, 2009, The deposit numbers of sub strains belonging to B. sphaericus species and named MBI5, MBI6, MBI6 are respectively registered as NRRL B-50199, NRRL B-50200 and NRRL B-50201.

In laboratory experiments carried out against mosquito larvae (Culex spp.), it has been found out that the larvicide effects of B. sphaericus MIB5,6,7 strains and presence of Bin genes are the same as in the commercial strains of B. sphaericus. Furthermore, it has been observed that in experiments against the mosquito larvae the inventive bacteria strains show faster effect in a higher ratio than the known B. sphaericus strains. In the applications of the previous technique, an extra process is performed in order to obtain protein from the isolates. By means of the invention, the protein isolation step in obtaining product stage is eliminated. It is observed that newly found bacteria strains (MBI5, MBI6MBI7) are effective when they are given to the medium in Which the larvae are present directly without performing protein isolation. At the same time Bacillus sphaericus strains show high larvicide effect both in polluted and fresh water. Various experimental studies have been carried out in order to test the effectiveness of the invention.

Experimental Studies

Single colonies of newly isolated bacterial strains and Bti 4Q4, Bti ATCC 35646, B. sphaericus and were cultivated on to NYSM (Nutrient Yeast Salt Medium) agar and incubated for 48 h at 30° C. Bacterial growth of each strain was harvested and resuspended in 10 ml of distilled water. Absorbance was adjusted to 0.2 with water and then 1 ml of suspension was added to 100 ml of fresh water/polluted water in 250 ml asks containing 100 larvae (at the stage of 3 or 4^{th} instar) of Culex spp. The inoculated flasks were maintained on laboratory bench and observed for 48 h at room temperature. In order to determine larvicidal bacterial strains, which were capable of killing 90% of larvae, positive and negative control flasks treated with reference strains and sterile water, respectively were kept the same condition as inoculating ones. After toxicity test, three strains of B. sphaericus (MBI 5, 6, 7) were selected as high toxic mosquitocidal bacteria and used for further studies. According, to the bioassay test results MBI 5,6,7 have potential to be toxic to larvae of Culex spp. Investigation of larvacidal features of three bacteria were done in fresh and polluted water that contained 100 larvae (see Table 1). Bti ATCC 35646, Bti 4Q4 and commercial B. sphaericus were used as positive control.

TABLE 1
The effectiveness of MBI 5, MBI 6, MBI 7 strains and
B.sphaericus, Bti ATCC 35646 and Bti 4Q4 bacteria
against Culex spp. larvae in polluted and fresh water.

| | Culex spp. Live larvae number | | |
|---|---|---|---|
| | (500 ml water/100 live larvae) | | |
| | | | Fresh |
| | Polluted water | | water |
| Bacteria name | 24 h | 48 h | 24 h |
| B.sphaericus | 10 | 4 | 0 |
| (500 μL) | | | |
| MBI 5 | 6 | 4 | 0 |
| (500 μL) | | | |
| MBI 6 | 7 | 3 | 0 |
| (500 μL) | | | |
| MBI7 | 9 | 2 | 0 |
| (500 μL) | | | |
| BtiATCC35646 | 20 | 70 | 16 |
| (500 μL) | | | |
| Bti 4Q4 | 34 | 32 | 24 |
| (500 μL) | | | |

According to the test results, it was found that MBI 5, MBI 6, MBI 7 strains are more effective in polluted water in 24 hours relative to the known B. sphaericus Bti ATCC 35646 and Bti 4Q4 bacteria. The effectiveness percentage of MBI 5, MBI 6, MBI 7 strains were determined as 94%, %93 and %91, respectively. In tests performed in fresh water, it was observed that MBI 5, MBI 6, MBI 7 strains and B. sphaericus bacteria have 100% success by killing all existing healthy larvae in 24 hours. On the other hand, it was found out that Bti ATCC 35646 and Bti 4Q4 bacteria are effective against larvae in ratio of 84% and 76% in fresh water, respectively (Table 1).

Diagnostic Studies

Phenotypic Diagnostic Studies

All of the methods provided to understand cell properties of three new strains of bacillus. MBI5, MBI6 and MBI7 were an aerobic. Gram-positive bacteria According to electron microscope images of MBI5, MBI6, MBI7 and B. sphaericus, they are rod-shaped bacteria (FIG. 6, FIG. 7, and FIG. 8) and similar withB. sphaericus (FIG. 5).

They were also growth 20-35° C. and the optimum growth temperatures were 27-30° C., Growth at 50° C. and 4° C. were not observed on nutrient agar. The physiological characteristics of MBI5, MBI6 and MBI7 were summarized and selective characteristics with related model as B. sphaericus were compared (Table 2).

TABLE 2
Phenotypic characteristics of strains MBI5, MBI6, MBI7
compared with commercial B.sphaericus

| Characteristics | MBI5 | MBI6 | MBI7 | B.sphaericus |
|---|---|---|---|---|
| Gram staining | + | + | + | + |
| Oxidase | − | − | − | − |
| Catalase | − | − | − | − |
| Capsule Staining | + | + | + | + |
| Endospor Staining | + | + | + | + |
| Hemolysis | + | + | + | + |
| Anaerobic test | − | − | − | − |
| Penicilline | + | + | + | + |

(+, positive; −, negative)

Fatty Acid Profile Analysis

Each MBI strains were characterized as unique and novel in terms of BIOLOG, FAME profiles and 16S rRNA sequencing data.

The cellular fatty acid profiles of MBI 5, 6, 7 and B. sphaericus were listed in Table 3. The major cellular fatty acids in MBI5 included iso-pentadecanoic acid (C_{15:0} iso. 45.00%) and C_{16:0} iso, 12.65%. Minor amounts of the iso-branched fatty acids C_{14:0} iso (0.60%), C_{16:0}(1.72%), C_{17:1} iso ω10c (1.43%). The major cellular fatty acids in MBI6 included iso-pentadecanoic acid (C_{15:0} iso, 14.99%) and C_{16:10} iso, 15.24%. Minor amounts of the fatty acids C_{16:0} (0.78%), C_{17:1} iso ω10c (1.40%). The major cellular fatty acids in MBI7 included iso-pentadecanoic acid (C_{15:0} iso, 45.84%) and C_{15:0} anteiso, 13.13%, Minor amounts of the iso-branched fatty acids C_{14:0} iso (0.68%), C_{18:1} iso ω9c (1.03%). Consequently, significant similarities in fatty acids profiles were found between B. sphaericus and MBI group. All of the groups MBI and B. sphaericus were identified with MIDI as Bacillus-sphaericus GC subgroup E.

TABLE 3
Cellular fatty acid composition of MBI 5, 6, 7 and B.sphaericus

| Numerical | | | | |
|---|---|---|---|---|
| Names of the | Percentage | Percentage | Percentage | Percentage |
| Fatty acids | % | % | % | % |
| (Peak names) | MBI 5 | MBI 6 | MBI 7 | B.sphaericus |
| 14:0 iso | 2.02 | 4.38 | 1.51 | 1.26 |
| 14:0 | 0.60 | — | 0.68 | 0.85 |
| 15:0 iso | 45.00 | 44.99 | 45.84 | 46.61 |
| 15:0 anteiso | 10.87 | 9.22 | 13.13 | 7.89 |
| 14:0 iso 3OH | — | — | — | 1.05 |
| 16:1 w7c | 9.93 | 12.38 | 9.55 | 6.80 |
| alkol | | | | |
| 16:iso | 12.65 | 15.24 | 8.14 | 5.48 |
| 16:1 w11c | 3.31 | 2.04 | 3.31 | 5.62 |
| 16:0 | 1.72 | 0.78 | 1.78 | 1.64 |
| 17:1 iso w10c | 1.43 | 1.40 | 2.35 | 4.92 |
| Sum In | 1.65 | 1.72 | 2.32 | 2.58 |
| Feature 4 | | | | |
| 17:0 iso | 6.11 | 4.67 | 5.69 | 10.86 |
| 17:0 anteiso | 4.70 | 3.19 | 4.67 | 4.45 |
| 18:1 w9c | — | — | 1.03 | — |
| Summed | 1.65 | 1.72 | 2.32 | 2.58 |
| Feature 4 | | | | |

Sequence Analysis with Nucleic Acid based 16S-rDNA PCR Amplification

DNA extraction from bacterial strains:

Total genomic DNA from bacterial strains was extracted according to methodology described by Jimenez with some modifications. The pure strains were cultured in Nutrient Agar (NA) solid medium 16-20 hours at 27 C and one single colony contaminated into 10 ml Nutrient Broth (NB) at 27 C for 3-4 hours until the absorbances up to 1 at 660 nm. The bacterial cells were collected from media afer 10 min at 2000 g centrifugation. The cells were suspended with 1 ml of Tris-EDTA buffer (10 mM Tris Base, 1 mM EDTA, 0.05% Tween 20, pH 9.0) and transfered into 2 ml microcentrifuge tube, centrifuged at 14000 g for 2 min, supernatant discarded from the tube and added 1 ml of Tris-EDTA buffer and repeated application for 3 times. Finally 300 μl of Tris-EDTA buffer added and boiled at 94 C for 30 min in water bath. Centrifuged at 14000 g for 2 min and 2000 DNA was collected from supernatant and stored at −20 for further PCR applications.

PCR amplification and purification of 16S rRNA:

16S rRNA genes of the bacterial DNA isolates (MBI 5, MBI 6, MBI 7 and Bacillus sphaericus serotype H for control) amplified by the PCR (BIORAD, Italy) using purified DNA and primers 27f and 1492r (Lane, 1991). PCR amplifications was caned out in total volume of 50 ul reaction mixture containing 0.2 mM of 27f and 1492r primers for total 16S, 1 U of pfu DNA polymerase (Fermentas, USA). 0.2 mM of each deoxynucleoside triphosphate (dNTP), 1 mM MgSO4, 10 mM Tris and 50 ng template DNA. PCR conditions were as follows:preamplification 94° C. for 5 min:denaturation at 94° C. for 30 s:annealing at 55° C. for 40 s:elongation at 72° C. for 2 min repeated 34 cycles and then post amplification for final extention 10 min at 72° C.

We designed specific two new primers for Bacillus sphaericus like members of Bacillaceae family. We amplified 550 bp of 16S rRNA gene fragments of the bacterial DNA isolates (MBI 5, MBI 6, MBI 7 and Bacillus sphaericus serotype H for control) by the PCR (BIORAD, Bing purified DNA and primers FAM1 and FAM2. PCR amplifications was caned out in total volume:of 50 ul reaction mixture containing 0.2 mM of FAM1 and FAM2 primers for 550 bp of 16S, 1 U of pfu DNA polymerase (Fermentas, USA), 0.2 mM of each deoxynucleoside triphosphate (dNTP), 1 mM MgSO4, 10 mM Tris and 50 ng template DNA. PCR conditions were as follows:preamplification 94° C. for 5 min:denaturation at 94° C. for 30 s:annealing at 51° C. for 40 s:elongation at 72° C. for 45 sec repeated 34 cycles and then post amplification for final extention 10 min at 72° C.

The amplified DNA products was detected by using Biorad image analysing system (BIORAD, Italy) after electrophoresis of PCR amplicons in a 1% agarose gel stained with ethidium bromide.

16S rRNA gene sequencing and phylogenetic analysis.

Pure amplification products were sequenced with a Prism ABI 3100 Genetic. Analyzer 16 caillaries, dideoxy terminator cycle sequencing kit (Applied Biosystems). The protocols used were due to manufacturers recommendations. Sequences were determined with an automated DNA sequencer (model: Prism ABI 3100; Applied Biosystems). Both strands were sequenced using the primers 27f, 1492r FAM1 and FAM2 (Lane, 1991; Nakamura, 1996). The clustal w program (Higgins et al., 1992) was used to align the 16S DNA sequences generated with sequences of Bacillus sphaericus like members from GenBank NCBI (Larsen et al., 1993). The sequences of 16s rDNA genes were obtained (FIG. 9, FIG. 10, FIG. 11).

Genetic distance was computed by using Kimura's two-parameter model (Kimura, 1980) and used for neighbour-joining analysis. Phylogenetic trees were constructed using neighbour-joining and maximum-parsimony methods provided by CLC Genomics Workbench_{—}2_{—}1_{—}1 both methods produced trees with similar topologies. Nucleotide sequences generated in this study have been deposited with GenBank under the accession numbers.

Another study was Neighbour-joining tree analysis that is based on 1450 nucleotide sequences. Confidence limits estimated from bootstrap analyses (100 replications) appear at the nodes. A maximum-parsimony tree generated from the sequence data exhibited similar topology to this tree. In the phylogenetic tree; MBI5, MBI6 and MBI7 clearly belonged to the strains of Bacillus sphaericus, as shown by the high bootstrap value (FIG. 4).

Determination of Toxin Genes

Toxin genes investigated according to methodology described by Nishiwaki et al., PCR of toxin genes of the bacterial DNA isolates (MBI 5, MBI 6, MBI 7 and Bacillus sphaericus serotype H for control) possesses has done for the genes encoding the mosquitocidal binary toxin (51 and 42 kDa), Mtx1, and Mtx2. PCR was constructed according to the following conditions:preamplification 94° C. for 2 min followed by 30 cycles of denaturation at 94° C. for 15 s, annealing at 55° C. for 30 s, and elongation at 72° C. for 1 min 30 s. The master mix consisted of 1 U of TSG polymerase (Biobasic, Canada), 1 mM MgSO4, 0.2 mM of each deoxynucleoside triphosphate (dNTP), 20 ng of template DNA, and 5 pmol of each primer in total volume of 50 ul reaction mixture.

The amplified DNA products was detected by using Biorad image analysing system (BIORAD, Italy) after electrophoresis of PCR amplicons in a 1% agarose gel stained with ethidium bromide (FIG. 1, FIG. 2).

The PCR amplification of Bin and Mtx toxin genes of MBI 5, 6, 7 and commercial B. Sphaericus have done. FIG. 1 reveals that B. sphaericus, MBI 5, MBI 6 and MBI 7 have Bin 51 and Bin 42 toxins. At the same time, MBI 5, MBI 6 and MBI 7 have not Mtx 1 and Mtx 2 toxins (FIG. 2). In addition, commercial B. sphaericus has both Bin and Mtx toxins.

1. MBI 5, MBI 6, MBI 7 bacterial strains which are sub strains of Bacillus sphaericus bacteria and which are used in biological control.

2. A MBI 5 bacteria strain for biological control according to claim 1, which is deposited with NRRL B-50199 number.

3. A MBI 6 bacteria strain for biological control according to claim 1, which is deposited with NRRL B-50200 number.

4. A MBI 7 bacteria strain for biological control according to claim 1, which is deposited with NRRL B-50201 number.

5. Bacterial strains for biological control according to claims 1 to 4, which are effective against mosquito larvae.

6. Bacteria strains for biological fight according to claim 5, which are effective when they are given directly to the medium in which the larvae are present without isolating protein.

7. Bacterial strains for biological control according to claim 6, which shows high larvicide effect in fresh and polluted water.

8. Bacteria strains for biological control according to claim 7, which are an aerobic, Gram-positive, rod-shaped bacteria

9. Bacterial strains for biological control according to claim 8, which have 99% closeness with Bacillus sp. ZYM and Bacillus sp. BD-95.

10. Bacterial strains for biological control according to claim 9 which includes Bin 51 and Bin 42 toxin genes.


SEQUENCE LISTING (3 sequences)

SEQ ID NO: 1 - DNA, 1458 bp, Bacillus sphaericus
  gene (1)..(1458)
acgctggcggcgtgcctatacatgcagtcgagcgaacagagaaggagcttgctccttcgacgttagcggcggacgggtgagtaacacgtgggcaacctaccttatagtttgggataactccgggaaaccggggctaataccgaataatctgtttcacctcatggtgaaacactgaaagacggtttcggctgtcgctataggatgggcccgcggcgcattagctagttggtgaggtaacggctcaccaaggcgacgatgcgtagccgacctgagagggtgatcggccacactgggactgagacacggcccagactcctacgggaggcagcagtagggaatcttccacaatgggcgaaagcctgatggagcaacgccgcgtgagtgaagaaggatttcggttcgtaaaactctgttgtaagggaagaacaagtacagtagtaactggctgtaccttgacggtaccttattagaaagccacggctaactacgtgccagcagccgcggtaatacgtaggtggcaagcgttgtccggaattattgggcgtaaagcgcgcgcaggtggtttcttaagtctgatgtgaaagcccacggctcaaccgtggagggtcattggaaactgggagacttgagtgcagaagaggatagtggaattccaagtgtagcggtgaaatgcgtagagatttggaggaacaccagtggcgaaggcgactatctggtctgtaactgacactgaggcgcgaaagcgtggggagcaaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcccgttgaccactgtagagatatagtttccccttcgggggcaacggtgacaggtggtgcatggttgtcgtcagctcgtgtcgtgagatgttgggttaagtcccgcaacgagcgcaacccttgatcttagttgccatcatttagttgggcactctaaggtgactgccggtgacaaaccggaggaaggtggggatgacgtcaaatcatcatgccccttatgacctgggctacacacgtgctacaatggacgatacaaacggttgccaactcgcgagagggagctaatccgataaagtcgttctcagttcggattgtaggctgcaactcgcctacatgaagccggaatcgctagtaatcgcggatcagcatgccgcggtgaatacgttcccgggccttgtacacaccgcccgtcacaccacgagagtttgtaacacccgaagtcggtgaggtaacctttggagccagccgccgaaggtggatagatgat

SEQ ID NO: 2 - DNA, 1347 bp, Bacillus sphaericus
  gene (1)..(1347)
tgcaagtcgagcgaacagagaaggagcttgctccttcgacgttagcggcggacgggtgagtaacacgtgggcaacctaccttatagtttgggataactccgggaaaccggggctaataccgaataatctgtttcacctcatggtgaaacactgaaagacggtttcggctgtcgctataggatgggcccgcggcgcattagctagttggtgaggtaacggctcaccaaggcgacgatgcgtagccgacctgagagggtgatcggccacactgggactgagacacggcccagactcctacgggaggcagcagtagggaatcttccacaatgggcgaaagcctgatggagcaacgccgcgtgagtgaagaaggatttcggttcgtaaaactctgttgtaagggaagaacaagtacagtagtaactggctgtaccttgacggtaccttattagaaagccacggctaactacgtgccagcagccgcggtaatacgtaggtggcaagcgttgtccggaattattgggcgtaaagcgcgcgcaggtggtttcttaagtctgatgtgaaagcccacggctcaaccgtggagggtcattggaaactgggagacttgagtgcagaagaggatagtggaattccaagtgtagcggtgaaatgcgtagagatttggaggaacaccagtggcgaaggcgactatctggtctgtaactgacactgaggcgcgaaagcgtggggagcaaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcccgttgaccactgtagagatatagtttccccttcgggggcaacggtgacaggtggtgcatggttgtcgtcagctcgtgtcgtgagatgttgggttaagtcccgcaacgagcgcaacccttgatcttagttgccatcatttagttgggcactctaaggtgactgccggtgacaaaccggaggaaggtggggatgacgtcaaatcatcatgccccttatgacctgggctacacacgtgctacaatggacgatacaaacggttgccaactcgcgagagggagctaatccgataaagtcgttctcagttcggattgtagctgcaactcgcctacatgaagccggaatcgctagtaatcgcgatcagcatgccgcggtgaatacgttcccgggccttgta

SEQ ID NO: 3 - DNA, 933 bp, Bacillus sphaericus
  gene (1)..(933)
ggagcttgctccttcgacgttagcggcggacgggtgagtaacacgtgggcaacctaccttatagtttgggataactccgggaaaccggggctaataccgaataatctgtttcacctcatggtgaaacactgaaagacggtttcggctgtcgctataggatgggcccgcggcgcattagctagttggtgaggtaacggctcaccaaggcgacgatgcgtagccgacctgagagggtgatcggccacactgggactgagacacggcccagactcctacgggaggcagcagtagggaatcttccacaatgggcgaaagcctgatggagcaacgccgcgtgagtgaagaaggatttcggttcgtaaaactctgttgtaagggaagaacaagtacagtagtaactggctgtaccttgacggtaccttattagaaagccacggctaactacgtgccagcagccgcggtaatacgtaggtggcaagcgttgtccggaattattgggcgtaaagcgcgcgcaggtggtttcttaagtctgatgtgaaagcccacggctcaaccgtggagggtcattggaaactgggagacttgagtgcagaagaggatagtggaattccaagtgtagcggtgaaatgcgtagagatttggaggaacaccagtggcgaaggcgactatctggtctgtaactgacactgaggcgcgaaagcgtggggagcaaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaacctaccaggtctgacttcccgtt